(19) United States
(12) Patent Application Publication
(10) Pub. No.: US 2026/0097528 A1
(43) Pub. Date: Apr. 9, 2026

(54) Box Cutting Tool

(71) Applicant: BoxPal Solutions LLC, Port St Lucie, FL (US)

(72) Inventor: Christian Forster, Port St Lucie, FL (US)

(73) Assignee: BoxPal Solutions LLC, Port St Lucie, FL (US)

(21) Appl. No.: 19/325,043

(22) Filed: Sep. 10, 2025

Related U.S. Application Data
(60) Provisional application No. 63/703,973, filed on Oct. 6, 2024.

(51) Int. Cl. B26B 5/00; B26B 11/00

(52) U.S. Cl. CPC B26B 5/005; B26B 5/003; B26B 11/00

(57) ABSTRACT

The present invention is directed towards a box cutting tool comprising a slide rack, slide lock assembly slidingly engaged with the slide rack, a scoring wheel, handle, and a utility blade designed to extend or retract from the slide rack. The slide lock assembly is configured to move bi-directionally along an axis of the slide rack from at least a first position to a second position. The box cutting tool is designed for shippers so they can easily reduce the overall dimension of a cardboard box or carton. The box cutting tool may measure, score, and cut providing a multifunctional tool that enhances the ease, efficiency, and safety of box size reduction or even breakdown for retail, industrial, ecommerce, or any other shipping environments.

### CROSS-REFERENCE TO RELATED APPLICATION

This application claims priority from pending U.S. Provisional Patent Application 63/703,973, filed on Oct. 6, 2024, the disclosure of which is included herein in its entirety.

### FIELD OF THE INVENTION

The current invention pertains to box cutters and more specifically to a box cutting tool designed to measure, score, and cut cardboard boxes or cartons used for shipping or storing so as to resize and reduce its overall dimension.

### BACKGROUND OF INVENTION

Cardboard boxes are known and are commonly made from a rigid material such as corrugated cardboard. Most corrugated cardboard boxes are made of kraft paper glued together and generally consist of a wavy fluted layer sandwiched between an inner and outer layer. This structure allows exceptional strength and durability to the box, making it ideal for storing and transporting heavier or delicate items safely while offering security and protection for its contents. Cardboard boxes are manufactured in a variety of sizes and are generally shaped as a cube or cuboid. It would be considered preferential to ship a product or products in a box that encloses these items with limited or no additional volume within the box. This helps create a snug fit for the contents to limit their movement, as loose items move around more, increasing the likelihood of damage or breakage.

In the instance where a shipper lacks a box or carton that perfectly fits its contents, a shipper may choose from a variety of packaging materials such as bubble wrap, foam, packaged air, or paper to fill the void of excess volume in the box. Larger boxes would require even more filler material and could lead to uneven protection. Therefore, this becomes an issue of increased material wasted, potential damage to the contents, and an additional cost of filler packaging materials.

Another issue of using a shipping box that is larger than its contents is the cost of shipping which is usually paid for by the shipper and in some cases the buyer. Carriers such as the USPS, FedEx, and UPS charge on dimensional weight pricing which is based on weight and box dimensions. Larger than needed box sizes often incur unnecessary, increased shipping fees for the shipper. This may lead to a decrease in sales for the shipper as they may hide the cost of shipping in an increased cost of their product. Shippers that use proper sized boxes may generally save on shipping costs. Another disadvantage of bulky, oversized boxed is the additional space needed in storage and fulfillment areas. These boxes are harder to manage, stack, and transport and may lead to fewer packages per shipment as they require more space in trucks, planes, or containers.

Shippers are generally classified as product manufacturers, distributors, ecommerce business owners, brick and mortar retailers, small business owners, artisans, and individuals selling on online marketplaces, to name a few. With the rising demand of purchases being made online so is the desire for shippers to keep their shipping costs and storage space to a minimum. As consumers are becoming more environmentally conscience, oversized boxes may create a larger carbon footprint as they may increase transportation space, fuel consumption, and emissions. Not to mention the use of additional packaging materials often ending up in landfills. These mentioned reasons may lead to a poor customer experience and feedback. Overall, these oversized boxes can negatively impact cost, efficiency, customer satisfaction, and sustainability.

What is needed is a box cutting tool with the ability to measure, score, and cut that is designed for shippers and can easily reduce the overall dimensions of a cardboard box by resizing it to fit its contents more securely.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some concepts in a simplified form as a prelude to the more detailed description that is presented later.

The present invention is directed toward a box cutting tool designed for shippers that can easily reduce the overall dimension of a cardboard box or carton. The box cutting tool may measure, score, and cut providing a multifunctional tool that enhances the ease, efficiency, and safety of box size reduction or even breakdown for retail, industrial, ecommerce, or any other shipping environments.

The box cutting tool may comprise a slide rack and slide lock assembly slidingly engaged with the slide rack. The slide lock assembly may slide bi-directionally about an axis along said slide rack from a first position to at least a second position. The box cutting tool may further comprise a scoring wheel to perforate a cardboard box or carton to assist in folding the box flaps more efficiently. The scoring wheel may have a plurality of pointed edges and may be disposed on a proximal portion of the slide rack. The scoring wheel may rotate about an axis perpendicular to a length of the slide rack. There may be a scoring wheel cover that is removably attached to the scoring wheel. The box cutting tool may comprise a handle removably secured to a bottom side of the slide rack.

The slide rack may comprise a first rack toothed portion and a second rack toothed portion on a first side and a second side of the slide rack. The first rack toothed portion and the second rack toothed portion may be formed linearly about an axis on a first side and a second side of the slide rack. The first rack toothed portion may comprise a plurality of first rack teeth. The second rack toothed portion may comprise a plurality of second rack teeth.

The slide lock assembly may further comprise a first section, a second section, and a slide lock. The slide lock may be disposed between the first section and second section. The slide lock may further comprise a first rack toothed portion and a second rack toothed portion on one or more than one inner portion of its lower recess. The first rack toothed portion of the slide lock may comprise a plurality of first rack teeth. The second rack toothed portion of the slide lock may comprise a plurality of second rack teeth. The slide lock may comprise a first grip and a second grip.

There may be a spring positioned on one or more than one outer portion of the slide lock. The spring may be disposed within the slide lock assembly and may share any abutting surface with any portion of the slide lock, first section, and second section.

The first rack teeth and second rack teeth of the slide lock may be interlocked with the first rack teeth and second rack teeth of the first side and second side of the slide rack in a locked first position. When a user simultaneously lifts the first grip and the second grip of the slide lock in an upward direction, the first rack teeth and second rack teeth of the slide lock may become disengaged from the first rack teeth and second rack teeth of the first side and second side of the slide rack. The lifting of the slide lock may create compression in one or more spring therefore disengaging the teeth and allowing the slide lock assembly to slide bi-directionally about an axis along the slide rack. Once a user decides on a second position for the slide lock assembly, they then release the first grip and second grip of the slide lock and the first rack teeth and second rack teeth of the first side and second side of the slide rack and the first rack teeth and second rack teeth of the slide lock become interlockably engaged. The slide lock assembly may further comprise a first foot and a second foot.

The utility blade may be any size or shape and may be disposed within the slide rack. The utility blade may be trapezoidal. The utility blade cover may be removably secured to the slide rack by a screw. The utility blade cover may comprise a first rack toothed portion and a second rack toothed portion on its outer surface. The first rack toothed portion may comprise a plurality of first rack teeth. The second rack toothed portion may comprise a plurality of second rack teeth. With the utility blade cover in a secured position to the slide rack, the first rack teeth and second rack teeth of the slide rack and the first rack teeth and the second rack teeth of the utility blade cover may be uniformly distanced and spaced consistent along an axis.

There may be a blade carriage that shares an abutting surface with the utility blade. The blade carriage may be disposed within the slide rack and may further comprise a blade slide button. The blade slide button may be slidingly engaged with the blade carriage and utility blade bi-directionally about an axis parallel to the slide rack from a first position to at least a second position.

There may be a plurality of equidistant measurement lines on a first side and a second side of the slide rack. There may be a numeral adjacent to any of the equidistant measurement lines. There may be a knurled screw removably attached to the slide lock assembly.

The primary object of the invention is to provide a box cutting tool designed to measure, score, and cut cardboard boxes or cartons used for shipping or storing so as to resize and reduce its overall dimension.

Still other embodiments of the present invention will become readily apparent to those skilled in this art from the following description wherein there is shown and described the embodiments of this invention, simply by way of illustration of the best modes suited to carry out the invention. As it will be realized, the invention is capable of other different embodiments and its several details are capable of modifications in various obvious aspects all without departing from the scope of the invention. Accordingly, the drawing and descriptions will be regarded as illustrative in nature and not as restrictive.

### BRIEF DESCRIPTION OF THE DRAWINGS

Various exemplary embodiments of this invention will be described in detail, wherein like reference numerals refer to identical or similar components, with reference to the following figures, wherein:

FIG. 1 is a perspective view of the box cutting tool in accordance with an embodiment of the present invention;

FIG. 2 is a front view of the box cutting tool;

FIG. 3 is a rear view of the box cutting tool;

FIG. 4 is a left side view of the box cutting tool;

FIG. 5 is another left side view of the box cutting tool with the slide lock assembly in a second position;

FIG. 6 is a right side view of the box cutting tool;

FIG. 7 is another right side view of the box cutting tool with the blade slide button, blade carriage, and utility blade in a second position;

FIG. 8 is a top view of the box cutting tool;

FIG. 9 is a bottom view of the box cutting tool;

FIG. 10 is a perspective view of the box cutting tool with the slide lock assembly removed from the slide rack;

FIG. 11 is an exploded, perspective view of the box cutting tool with the slide lock assembly removed from the slide rack;

FIG. 12 is an exploded, perspective view of the slide lock assembly;

FIG. 13 is a perspective view of the slide lock; and

FIG. 14 is another perspective view of the slide lock.

### DETAILED DESCRIPTION OF THE PREFERRED EMBODIMENT

The claimed subject matter is now described with reference to the drawings. In the following description, for purposes of explanation, numerous specific details are set forth in order to provide a thorough understanding of the claimed subject matter. It may be evident, however, that the claimed subject matter may be practiced with or without any combination of these specific details, without departing from the spirit and scope of this invention and the claims.

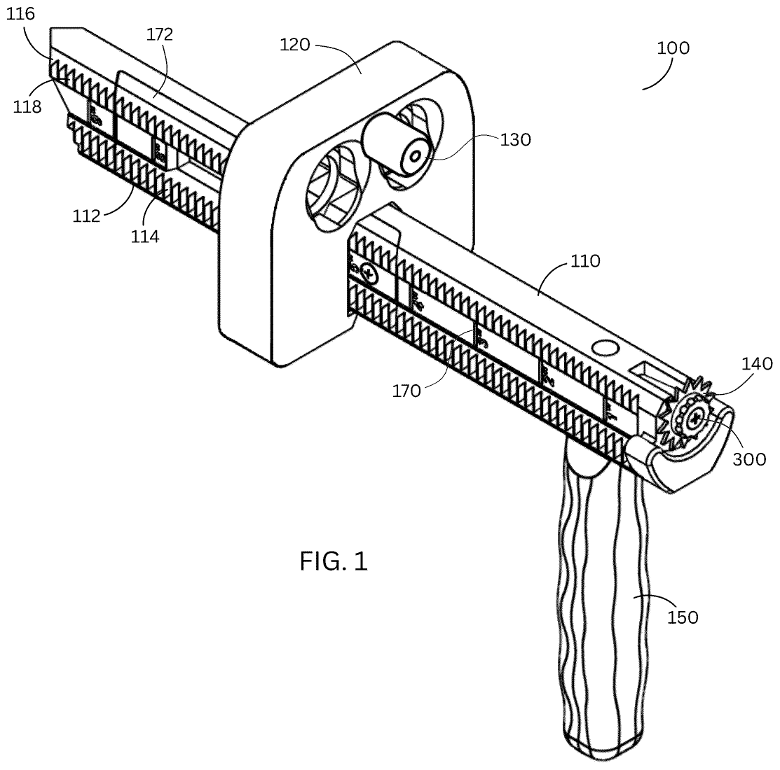

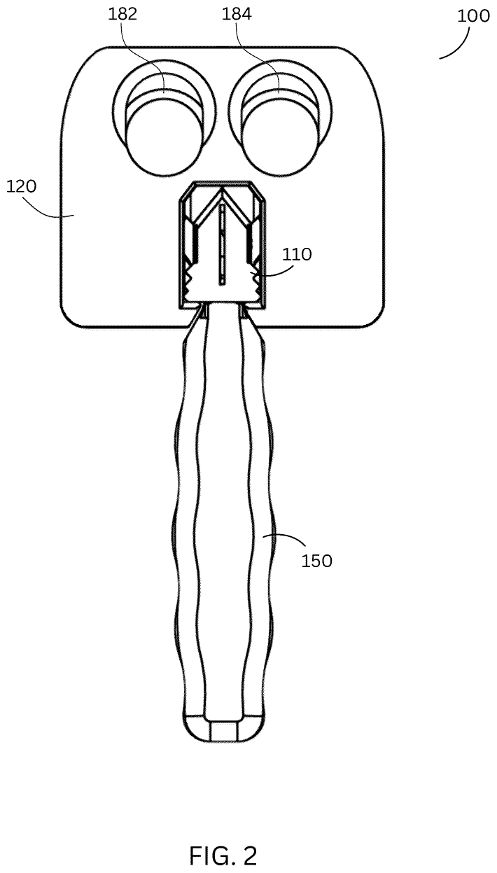

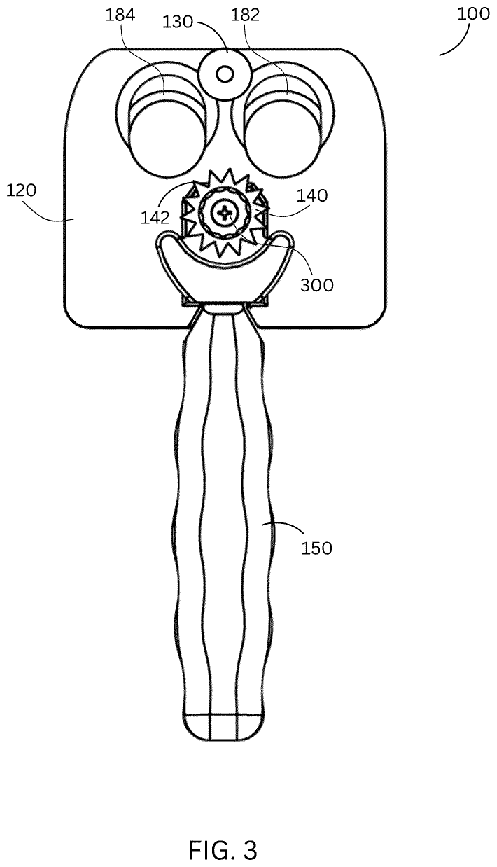

Referring to FIGS. 1-4 is a box cutting tool 100 comprising a slide rack 110, slide lock assembly 120, utility blade 164, scoring wheel 140, and a handle 150. The box cutting tool 100 may be any size or shape and made from any materials. The box cutting tool 100 may be designed to measure, score, and cut a cardboard box at any location and in any direction. In the preferred embodiment the box cutting tool 100 may be designed to score a cardboard box with the scoring wheel 140 along its width and length and slice the box with the utility blade 164 along its height. The scoring line of the cardboard box may provide a guide in the folding of the newly sliced panels of the box. The scoring wheel 140 may be designed to perforate a line along a desired fold line allowing the material of the box to bend more easily. The box cutting tool 100 may be designed to reduce the overall height and volume of any box made from cardboard or any other materials.

The slide rack 110 of the box cutting tool 100 may be any size or shape and may be made from any materials. The slide rack 110 may have a proximal first end and a distal second end. The slide rack 110 may have one or more planar sides. The slide rack 110 may comprise a first rack toothed portion 112 and a second rack toothed portion 116 on a first side 102 and a second side 104 of the box cutting tool 100. The first rack toothed portion 112 and the second rack toothed portion 116 may be formed linearly about an axis on a first side 102 and a second side 104 of the slide rack 110. The first rack toothed portion 112 may comprise a plurality of first rack teeth 114 having any depth or any linear pitch. The second rack toothed portion 116 may comprise a plurality of second rack teeth 118 having any depth or any linear pitch. There may be any number of first rack teeth 114 that are made from any material and of any size or shape and there may be any number of second rack teeth 118 that are made from any material and of any size or shape. The first rack teeth 114 and second rack teeth 118 may be vertical along an axis and may be parallel to their adjacent teeth. In the preferred embodiment the first rack teeth 114 of the first rack toothed portion 112 and the second rack teeth 118 of the second rack toothed portion 116 are vertically arranged in alignment along an axis.

The slide rack 110 may have any number of equidistant measurement lines 170 located in any position. The measurement lines 170 may be positioned on a first side 102 and a second side 104 of the slide rack 110 and may be spaced in any increments of millimeters, centimeters, inches, or any other unit of measurement for distance. The measurement lines 170 may have increments that are identically or differently spaced on a first side 102 and a second side 104 of the slide rack 110. In the preferred embodiment the measurement lines 170 are spaced evenly along the first side 102 and second side 104 of the slide rack 110 in dissimilar measuring increments. There may be any numeral with any corresponding symbol or abbreviation for measurement adjacent to any of the measurement lines 170.

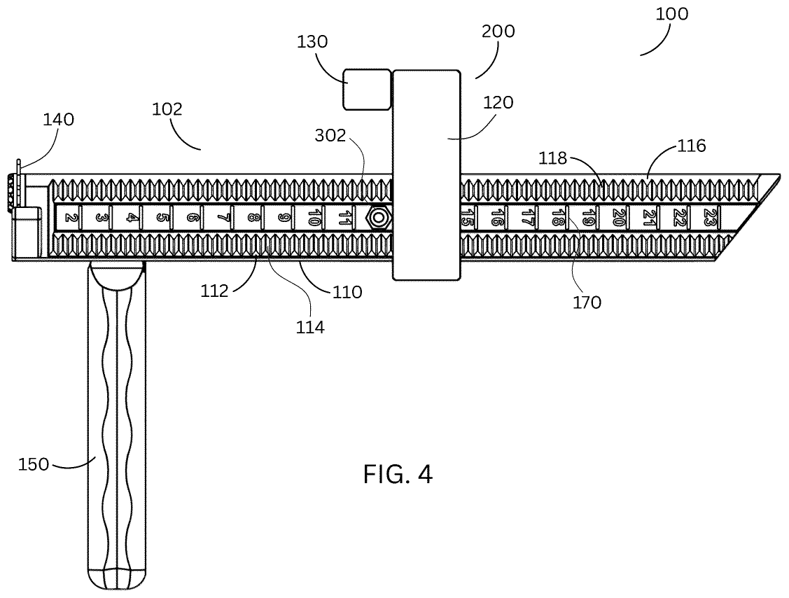

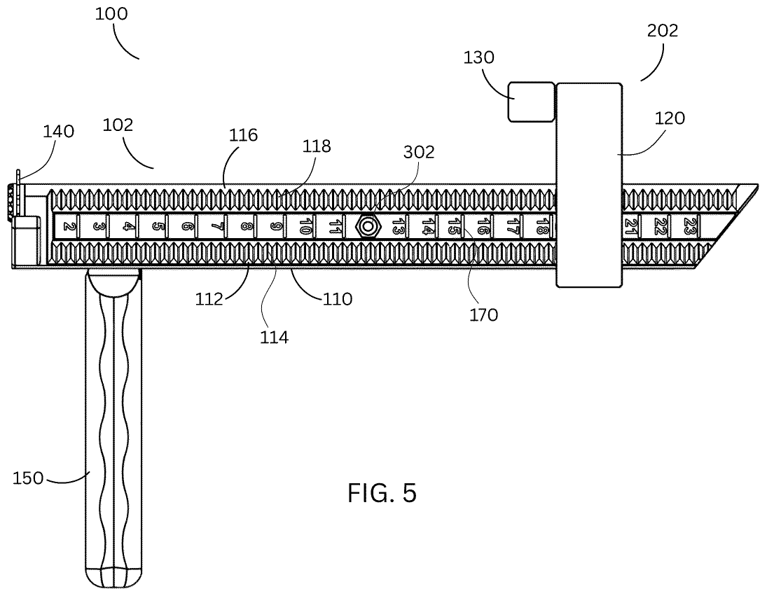

The slide lock assembly 120 may be any size or shape and may be comprised of any material. The slide lock assembly 120 may be designed to slide bi-directionally about an axis along the slide rack 110. The slide lock assembly 120 may be slid to any position about the slide rack 110. Referring specifically to FIGS. 4-5, the slide lock assembly 120 may slide from a first position 200 to a second position 202 or any other position, and from the second position 202 back to the first position 200 or any other position. In an engaged first position 200 the slide lock assembly 120 may be immovably fixed about the slide rack 110. In an engaged second position 202 the slide lock assembly 120 may be immovably fixed about the slide rack 110. In a disengaged position the slide lock assembly 120 may slide bi-directionally about an axis perpendicular to the slide rack 110. The slide lock assembly 120 may further comprise a knurled screw 130. The knurled screw 130 may be any size or shape and made from any materials. The knurled screw 130 may be magnetically attached or removably attached by any means.

The scoring wheel 140 may be may be any size or shape and made from tungsten carbide, steel, or any other metal or any material and may be positioned on the proximal first end of the slide rack 110. The scoring wheel 140 may be any type of cutter with any type of cutting edge. There may be any number of pointed edges 142 on the scoring wheel 140. The scoring wheel 140 may be designed to rotate about an axis perpendicular to a length of the slide rack 110. The scoring wheel 140 may be removably secured to the slide rack 110 with a screw 300. A user may puncture an inner surface of a box with the scoring wheel 140 and may move the box cutting tool 100 along an inner or outer perimeter causing any number of pointed edges 142 of the scoring wheel 140 to create a perforated line on a box. There may be a scoring wheel cover 144 that is removably secured to the scoring wheel 140 to prevent any of the pointed edges 142 from puncturing any unintended surfaces.

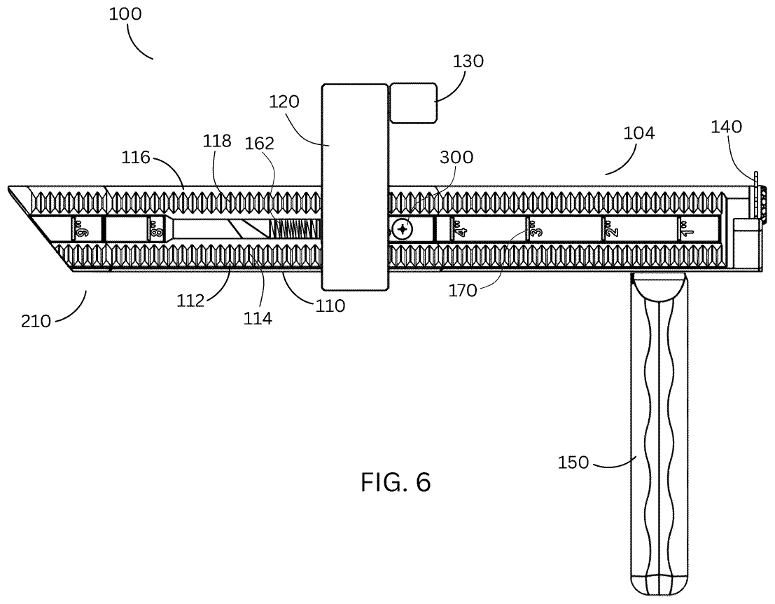

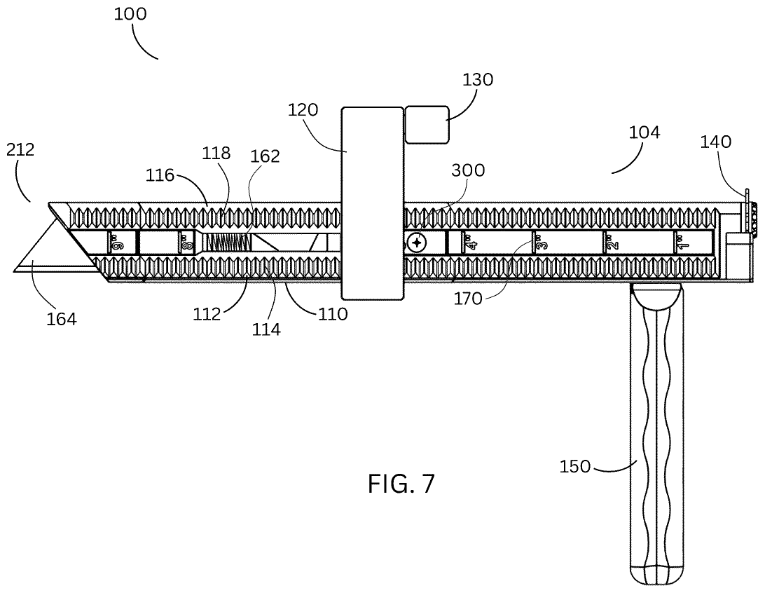

Referring to FIGS. 6-7 the blade carriage 160, blade slide button 162, and utility blade 164 may slide from a first blade position 210 to a second blade position 212. In a first blade position 210, the blade carriage 160, blade slide button 162, and utility blade 164 may be fully or partially disposed within an inner portion of the slide rack 110. In a second blade position 212, the blade carriage 160, blade slide button 162, and utility blade 164 may still be fully or partially disposed within an inner portion of the slide rack 110. In a second blade position 212, any portion of the utility blade 164 may be protracted from an aperture of the distal second end of the slide rack 110. A user may slide the blade slide button 162 in a direction opposite the distal second end to retract the utility blade 164 and move the blade carriage 160 from a second blade position 212 to a first blade position 210. The blade carriage 160 may be designed to carry and house the utility blade 164. The blade slide button 162 and blade carriage 160 may have any blade locking mechanism to allow a user to extend or retract the utility blade 164 to a desired length and lock it in place, providing greater control over a desired depth of cut and safe storage of the utility blade 164 within a portion of the slide rack 110. The blade slide button 162 and blade carriage 160 may not lock and only be extended when the blade slide button 162 is held in a second blade position 212 by a user. When the blade slide button 162 is released the blade carriage 160, blade slide button 162, and utility blade 164 may automatically retract back to a first blade position 210.

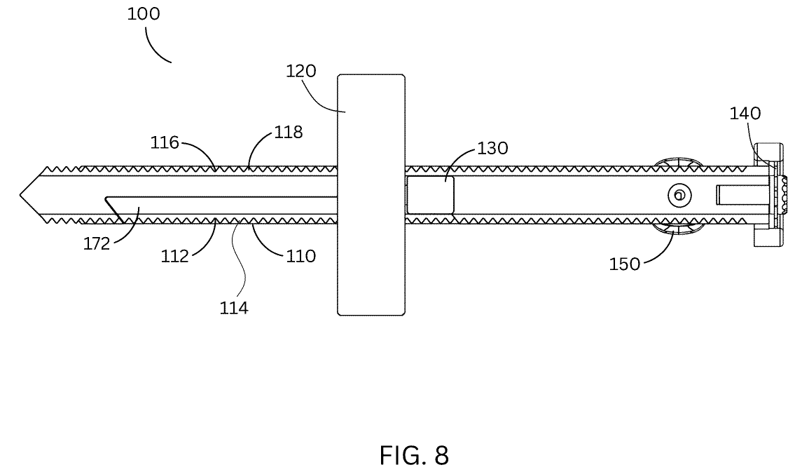

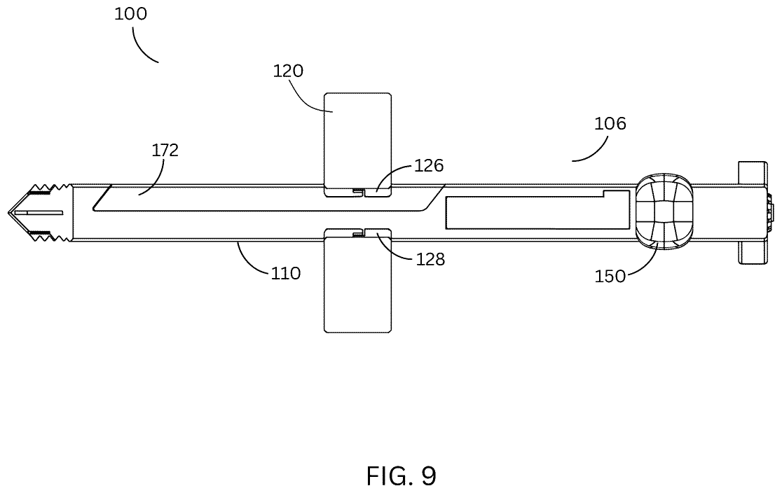

Referring to FIGS. 8-9 the handle 150 may be any size or shape and may be made from any materials. The handle 150 may allow a user enhanced leverage when cutting a vertical portion of a box with the utility blade 164 of the box cutting tool 100. The handle 150 may be permanently or removably secured to a bottom side 106 of the slide rack 110 and may be positioned near the proximal first end of the slide rack 110. The design of the handle 150 may allow the slide lock assembly 120 to slide and lock at any fixed position along the slide rack 110.

The slide lock assembly 120 may further comprise a first foot 126 and a second foot 128. The first foot 126 and the second foot 128 may be designed to prevent the slide lock assembly 120 from detaching from the slide rack 110 when interlockably engaged or disengaged from the slide rack 110. The first foot 126 and second foot 128 may share any abutting surface with any portion of the slide rack 110.

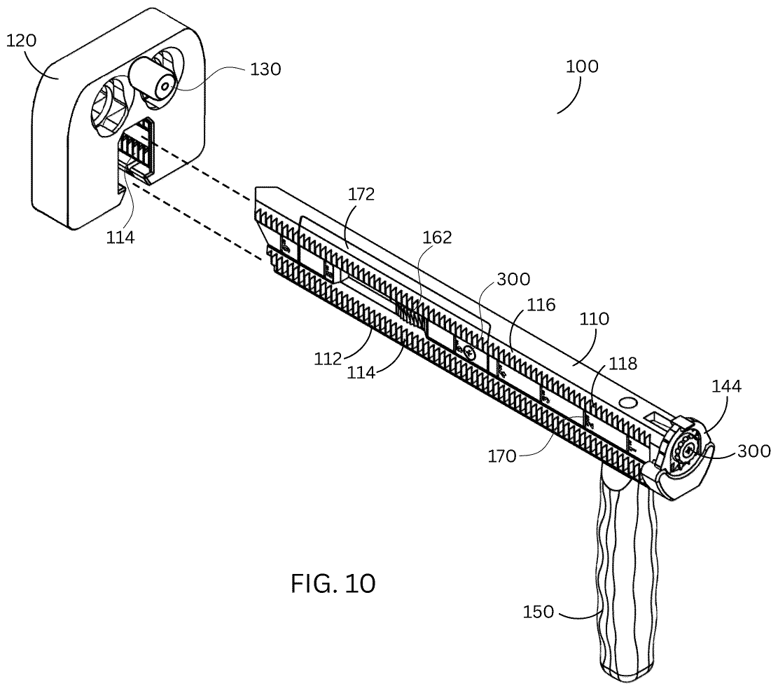

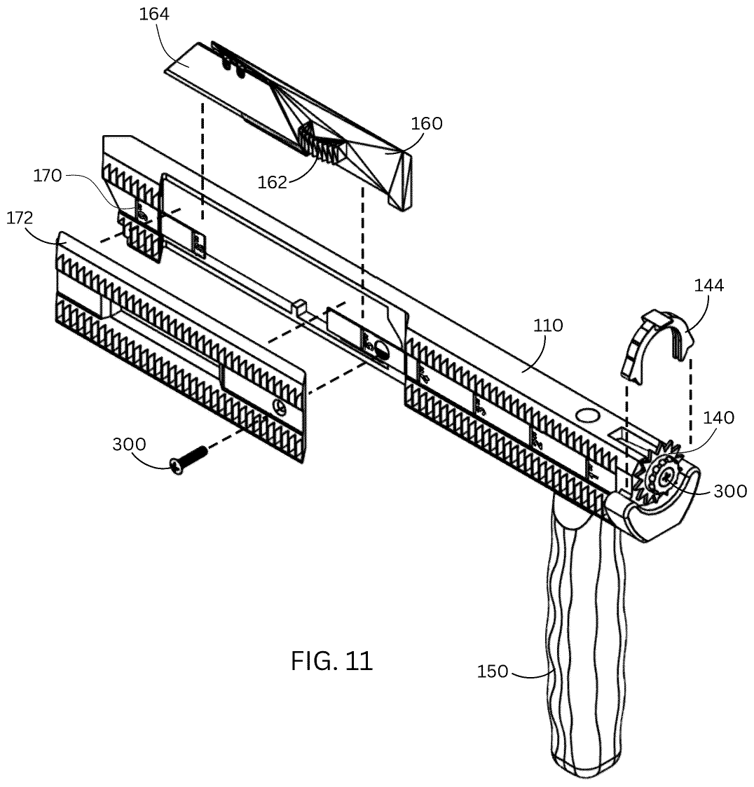

Referring to FIGS. 10-11 the utility blade cover 172 may be removably secured to the slide rack 110 by a screw 300 or by any other means. The screw may removably secure to a nut 302 on a first side 102 of the slide rack 110. The utility blade cover 172 may comprise a first rack toothed portion 112 and a second rack toothed portion 116 on its outer surface. The first rack toothed portion 112 may comprise a plurality of first rack teeth 114 having any depth or any linear pitch. The second rack toothed portion 116 may comprise a plurality of second rack teeth 118 having any depth or any linear pitch. With the utility blade cover 172 in a secured position to the slide rack 110, the first rack teeth 114 and second rack teeth 118 of the slide rack 110 and the first rack teeth 114 and the second rack teeth 118 of the utility blade cover 172 may be uniformly distanced and spaced consistent along an axis.

The blade slide button 162 may be permanently or removably secured to the blade carriage 160 by any means. The blade carriage 160 may be any size or shape and made of any materials. The utility blade 164 may be a standard trapezoid blade, a hook or concave blade, a snap off blade, or any other size or shape or type of blade. In the preferred embodiment the blade carriage 160 may be designed to hold any utility blade 164 that may be replaced when the sharp edges become dull.

The screws 300 may be any size or shape. The screws 300 may have any driver such as slotted, crosshead, square, triangle, any polygonal shape, or any other shape. The screws 300 may have any screw head such as flat, oval, binding, round, or any other shape.

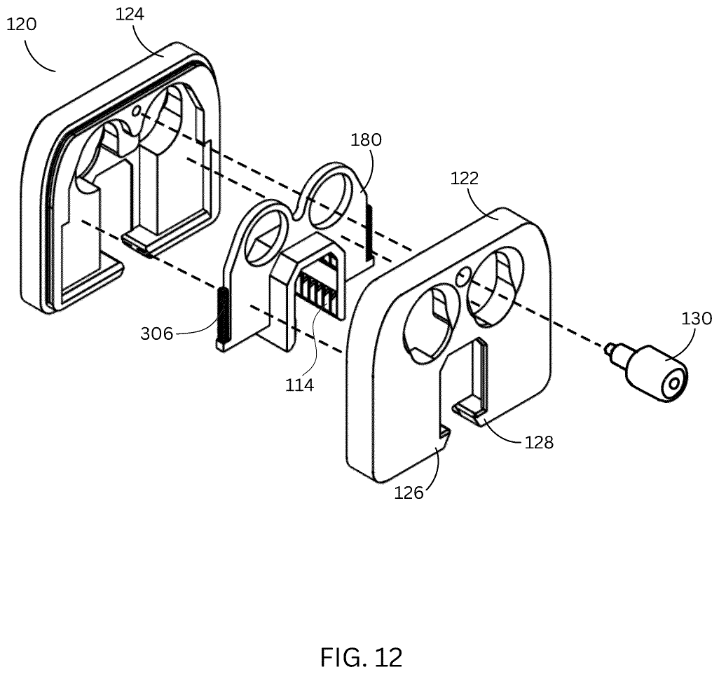

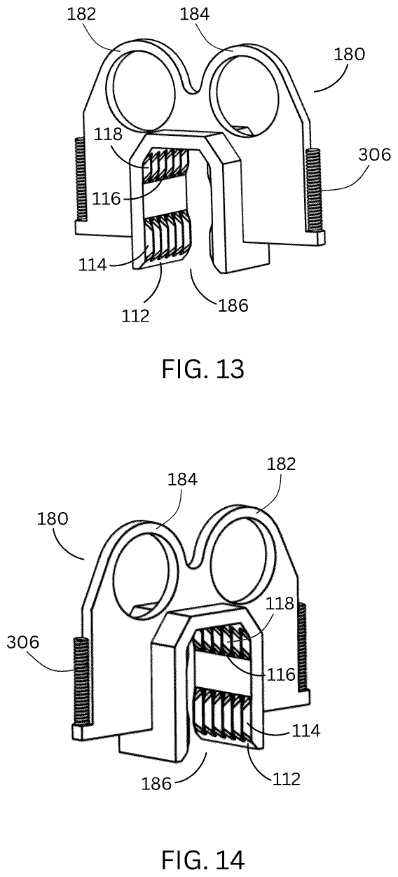

Now referring to FIGS. 12-14 the slide lock assembly 120 may further comprise a first section 122, a second section 124, and a slide lock 180. The slide lock 180 may be disposed between the first section 122 and second section 124. The first section 122 and second section 124 may be removably or permanently secured by any means. The slide lock 180 may be any size or shape and made from any materials. The slide lock 180 may further comprise a first rack toothed 112 portion and a second rack toothed portion 116 on one or more than one inner portion of its lower recess 186. The first rack toothed portion 112 of the slide lock 180 may comprise a plurality of first rack teeth 114 having any depth and any linear pitch. The second rack toothed portion 116 of the slide lock 180 may comprise a plurality of second rack teeth 118 having any depth and any linear pitch. The first rack teeth 114 and second rack teeth 118 of the slide lock 180 may be vertical along an x-axis and may be parallel to their adjacent teeth. There may be a first foot 126 and a second foot 128 on both the first section 122 and second section 124 of the slide lock assembly 120.

There may be a spring 306 positioned on one or more than one outer portion of the slide lock 180. The spring 306 may be disposed within the slide lock assembly 120 and may share any abutting surface with any portion of the slide lock 180, first section 122, and second section 124.

The first rack teeth 114 and second rack teeth 118 of the slide lock 180 may be interlocked with the first rack teeth 114 and second rack teeth 118 of the first side 102 and second side 104 of the slide rack 110 in a locked first position 200. When a user simultaneously lifts the first grip 182 and the second grip 184 of the slide lock 180 in an upward direction, the first rack teeth 114 and second rack teeth 118 of the slide lock 180 may become disengaged from the first rack teeth 114 and second rack teeth 118 of the first side 102 and second side 104 of the slide rack 110. The lifting of the slide lock 180 may create compression in one or more spring 306 therefore disengaging the teeth and allowing the slide lock assembly 120 to slide bi-directionally about an axis along the slide rack 110. Once a user decides on a second position 202 for the slide lock assembly 120, they then release the first grip 182 and second grip 184 of the slide lock 180 and the first rack teeth 114 and second rack teeth 118 of the first side 102 and second side 104 of the slide rack 110 and the first rack teeth 114 and second rack teeth 118 of the slide lock 180 become interlockably engaged.

In an alternative embodiment the box cutting tool may have a level built into one or more sides of the handle 150 or slide rack 110. The level may be a bubble level or any type of level and may aid a user to score a more precise straight line. There may be an LED light on a proximal portion of the box cutting tool 100 to help a user eliminate shadows that may exist in deeper boxes or cartons having great height. There may be an on/off button for the light on the handle 150, slide rack 110, or any other component of the box cutting tool 100. In another alternative embodiment there may be a motor that drives the scoring wheel 140 to rotate automatically where the user simply guides the box cutting tool 100 along the surface of a box.

What has been described above includes examples of the claimed subject matter. It is, of course, not possible to describe every conceivable combination of components or methodologies for purposes of describing the claimed subject matter, but one of ordinary skill in the art can recognize that many further combinations and permutations of such matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

The preceding description of the disclosed embodiments is provided to enable any person skilled in the art to make or use the present invention. Various modifications to these embodiments will be readily apparent to those skilled in the art, and the generic principles defined herein may be applied to other embodiments without departing from the spirit or scope of the invention. Thus, the present invention is not intended to be limited to the embodiments shown herein but is to be accorded the widest scope consistent with the following claims and the principles and novel features disclosed herein.

1. A box cutting tool comprising
a) a slide rack having more than one side;
b) a slide lock assembly slidingly engaged with said slide rack;
c) wherein said slide lock assembly slides bi-directionally about an axis along said slide rack from a first position to at least a second position;
d) a scoring wheel disposed on a proximal portion of said slide rack;
e) a utility blade disposed within said slide rack; and
f) a handle disposed on a bottom side of said slide rack.

2. The box cutting tool as in claim 1
a) wherein said slide rack further comprises at least a first side and a second side;
b) wherein said first side comprises a first rack toothed portion and a second rack toothed portion;
c) wherein said first rack toothed portion further comprises a plurality of first rack teeth; and
d) wherein said second rack toothed portion further comprises a plurality of second rack teeth.

3. The box cutting tool as in claim 2
a) wherein said second side of said slide rack comprises a said first rack toothed portion and a said second rack toothed portion;
b) wherein said first rack toothed portion further comprises a plurality of first rack teeth; and
c) wherein said second rack toothed portion further comprises a plurality of second rack teeth.

4. The box cutting tool as in claim 1
a) wherein said slide lock assembly further comprises a slide lock and a first section and a second section;
b) wherein said slide lock is disposed between said first section and said second section; and
c) wherein one or more springs share an abutting surface with said slide lock and said first section and said second section.

5. The box cutting tool as in claim 4
a) wherein said slide lock further comprises a lower recess and a first grip and a second grip;
b) wherein one or more inner portions of said lower recess may further comprise a first rack toothed portion and a second rack toothed portion;
c) wherein said first rack toothed portion further comprises a plurality of first rack teeth; and
d) wherein said second rack toothed portion further comprises a plurality of second rack teeth.

6. The box cutting tool as in claim 1 wherein said slide lock assembly further comprises a first foot and a second foot.

7. The box cutting tool as in claim 1 wherein said scoring wheel further comprises a plurality of pointed edges.

8. The box cutting tool as in claim 1 wherein said scoring wheel rotates about an axis perpendicular to a length of said slide rack.

9. The box cutting tool as in claim 1 further comprising
a) a utility blade cover removably secured to said slide rack by a screw;
b) wherein said utility blade cover further comprises a first rack toothed portion and a second rack toothed portion;
c) wherein said first rack toothed portion further comprises a plurality of first rack teeth; and
d) wherein said second rack toothed portion further comprises a plurality of second rack teeth.

10. The box cutting tool as in claim 9 wherein said first rack teeth and said second rack teeth of said utility blade cover and said first rack teeth and said second rack teeth of said slide rack are uniformly distanced and spaced consistent along an axis.

11. The box cutting tool as in claim 1
a) wherein said slide lock assembly is engaged with said slide rack in a locked first position; and
b) wherein said locked first position further comprises said first rack teeth and said second rack teeth of said slide rack interlocked with said first rack teeth and second rack teeth of said slide lock.

12. The box cutting tool as in claim 1 further comprising
a) a blade carriage comprising a blade slide button;
b) wherein said utility blade shares an abutting surface with said blade carriage; and
c) wherein said blade slide button is slidingly engaged with said blade carriage and said utility blade bi-directionally about an axis parallel to said slide rack from a first position to at least a second position.

13. The box cutting tool as in claim 1 further comprising a plurality of equidistant measurement lines on at least a said first side of said slide rack.

14. The box cutting tool as in claim 13 wherein said plurality of equidistant measurement lines further comprise an adjacent numeral.

15. The box cutting tool as in claim 1 wherein said handle is removably secured to a bottom side of said slide rack.

16. The box cutting tool as in claim 1 further comprising a knurled screw removably attached to said slide lock assembly.

17. The box cutting tool as in claim 1 wherein said scoring wheel further comprises a removably attached scoring wheel cover.

18. The box cutting tool as in claim 1 wherein said utility blade is trapezoidal.
